(19) United States
(12) Patent Application Publication
(10) Pub. No.: US 2009/0078696 A1
(43) Pub. Date: Mar. 26, 2009

(54) METHOD OF CONTROLLING COOKER

(76) Inventors: Kyung-Jin Kim, Daegu City (KR); Jung-Ho Bae, Gyeongsangnam-do (KR)

Correspondence Address: KED & ASSOCIATES, LLP, P.O. Box 221200, Chantilly, VA, 20153-1200, US

(21) Appl. No.: 12/159,648

(22) PCT Filed: Jan. 26, 2007
(86) PCT No.: PCT/KR07/00479

§ 371 Date: Jun. 30, 2008

(30) Foreign Application Priority Data
Jan. 26, 2006 (KR) 10-2006-0008403
Jan. 26, 2006 (KR) 10-2006-0008409
Feb. 2, 2006 (KR) 10-2006-0010250

(51) Int. Cl. H05B 1/02

(52) U.S. Cl. 219/506

(57) ABSTRACT

The present invention relates to a oven and a method of controlling the same. In a method of controlling a oven for receiving a variety of operating and setting instructions and displaying various kinds of data related to the instructions, which comprises the steps of (A) displaying, by a control module, any one of menu lists included in a menu list image on a display unit to be relatively larger than the other menu lists; (B) receiving, by an input unit, an instruction to select any one of the menu lists displayed on the display unit at step (A); (C) displaying, by the control module, the menu list selected at step (B) on the display unit to be relatively larger than the other menu lists; (D) receiving, the input unit, an instruction to select any one of menus included in the menu list selected at step (B); (E) displaying, by the control module, a cooking method and image for the menu selected at step (D) on the display unit; (F) receiving, by the input unit, a cooking start instruction; and (G) performing a cooking operation in accordance with the cooking method for the menu selected at step (D) by means of the cooking start instruction received by the input unit at step (F). According to the present invention, there are advantages in that an item to be set can be easily discriminated and accurately selected, a cooking method can be easily discriminated and food can be easily cooked accordingly, and a variety of settings can be made according to users.

### TECHNICAL FIELD

The present invention relates to a oven, and more particularly, to a method of controlling a oven for receiving various kinds of instructions related to operations of the oven and displaying various kinds of data for the instructions.

### BACKGROUND ART

A oven is used to cook food using electricity or gas supplied from the outside, and is provided with a controller for controlling operations of its own. The controller includes an input unit for receiving instructions input by a user and a display unit for displaying various kinds of information on the operations of the oven.

However, a related art oven has the following problems:

First, in the related art oven, items of an input cooking menu are displayed on the display device at a certain size and color. Therefore, there is a disadvantage in that it is not easy for a user to discriminate menu items displayed on the display device and select a specific menu item.

Further, only a simple cooking method expressed simply with characters is displayed on the display device. Therefore, there is an inconvenience in that a user should separately input every process of a cooking method to the controller.

Furthermore, a user should input cooking information, i.e. cooking temperature, cooking time, heating method and the like, whenever a user cooks according to a cooking method other than the cooking methods previously stored in the controller. Therefore, there is another inconvenience in that the user should input cooking information every time whenever the user cooks.

### DISCLOSURE OF INVENTION

### Technical Problem

Accordingly, the present invention has been conceived to solve the aforementioned problems in the prior art. An object of the present invention is to provide a method of controlling a oven wherein an item to be set can be more easily discriminated.

Another object of the present invention is to provide a method of controlling a oven wherein a setting item can be more accurately selected.

A further object of the present invention is to provide a method of controlling a oven wherein a cooking method can be more easily discriminated.

A still further object of the present invention is to provide a method of controlling a oven wherein food can be more easily cooked in accordance with a cooking method.

A still further object of the present invention is to provide a method of controlling a oven wherein a cooking method and the like can be variously set according to users.

### Technical Solution

According to an aspect of the present invention for achieving the objects, there is provided a method of controlling a oven for receiving a variety of operating and setting instructions and displaying various kinds of data related to the instructions, which comprises the steps of (A) displaying, by a control module, any one of menu lists included in a menu list image on a display unit to be relatively larger than the other menu lists; (B) receiving, by an input unit, an instruction to select any one of the menu lists displayed on the display unit at step (A); (C) displaying, by the control module, the menu list selected at step (B) on the display unit to be relatively larger than the other menu lists; (D) receiving, the input unit, an instruction to select any one of menus included in the menu list selected at step (B); (E) displaying, by the control module, a cooking method and image for the menu selected at step (D) on the display unit; (F) receiving, by the input unit, a cooking start instruction; and (G) performing a cooking operation in accordance with the cooking method for the menu selected at step (D) by means of the cooking start instruction received by the input unit at step (F).

According to another aspect of the present invention, there is provided a method of controlling a oven for receiving a variety of operating and setting instructions and displaying various kinds of data related to the instructions, which comprises the steps of (A) displaying, by a control module, any one of menu setting items included in a menu setting image on a display unit to be relatively larger than an equally divided area of an entire display area and displaying the other menu setting items in equally divided areas of a remaining display area, respectively; (B) receiving, by an input unit, an instruction to select any one of the menu setting items displayed on the display unit at step (A); and (C) displaying, by the control module, the menu setting item selected at step (B) on the display unit to be relatively larger than the equally divided area of the entire display area and displaying the other menu setting items in equally divided areas of a remaining display area, respectively.

According to a further aspect of the present invention, there is provided a method of controlling a oven for receiving a variety of operating and setting instructions and displaying various kinds of data related to the instructions, which comprises the steps of (A) displaying, by a control module, any one of menu setting items included in a menu setting image on a display unit to be placed on two of equally divided areas obtained by equally dividing an entire display area into the number of menu setting items plus 1 (one) and displaying the other menu setting items to be placed on the remaining item display areas, respectively; (B) receiving, by an input unit, an instruction to select any one of the menu setting items displayed on the display unit at step (A); and (C) displaying, by the control module, the menu setting item selected at step (B) on the display unit to be placed on the two equally divided areas and displaying the other menu setting items to be placed on the remaining item display areas, respectively.

Here, step (B) may comprise the steps of (B1) displaying, by the control module, an initial value on each of the item display areas assigned to the display unit; (B2) receiving, by the input unit, an instruction to input an item value displayed in the item display area; (B3) displaying, by the control module, the item value input at step (B2) on the item display area; and (B4) storing, by the control module, the item value input at step (B2) in a storage unit.

Further, step (B3) may comprise the steps of (B31) receiving, by the input unit, an instruction to change an item displayed on the item display area into another item; (B32) displaying, by the control module, a list of items on the item display area in accordance with the item change instruction input at step (B31); and (B33) receiving, by the input unit, an instruction to select one item in the item list displayed at step (B32).

In addition, step (B31) may comprise the steps of (B311) receiving, by the input unit, an instruction to request registering a menu including an item with a changed item value; (B312) receiving, by the input unit, an instruction to input a new menu name of a menu which will be registered in accordance with the menu registration instruction; and (B313) storing, by the input unit the menu including the item with the item value changed at step (B311) in the storage unit.

The method of the present invention may further comprise the steps of (D) receiving, by the input unit, a cooking start instruction in accordance with the selected menu item; (E) performing, by the control module, a cooking operation in accordance with the item value stored in the menu item selected at step (B) by means of the cooking start instruction received by the input unit at step (D); and (F) displaying, by the control module, a current cooking state on the display unit.

According to a still further aspect of the present invention, there is provided a method of controlling a oven for receiving a variety of operating and setting instructions and displaying various kinds of data related to the instructions, which comprise the steps of (A) receiving, by an input unit, a menu mode selection instruction; (B) displaying, by a control module, a menu list stored in a storage unit on a display unit in accordance with the menu mode selection instruction received by the input unit at step (A); (C) receiving, by the input unit, an instruction to select any one menu in the menu list displayed on the display unit at step (B); (D) displaying, by the control module, a cooking method and image for the menu received by the input unit at step (C) on the display unit; (E) receiving, by the input unit, a cooking start instruction; and (F) performing, by the control module, a cooking operation in accordance with the cooking method for the menu displayed on the display unit at step (D) by means of the cooking start instruction received by the input unit at step (E).

The image may include at least one of a still image, a moving image and an avatar, which are related to the menu or cooking method.

The cooking method displayed on the display unit at step (D) may include at least one of heating intensity, heating method, heating temperature and heating time for each cooking stage.

Further, step (F) may comprise the steps of (F1) receiving, by the input unit, an instruction to select any one of stages; (F2) determining, by the control module, whether the input unit has received an instruction to select any one of stages at step (F1); and (F3) performing, by the control module, a cooking operation at the selected stage by means of the stage selection instruction received by the input unit at step (F2).

Step (F) may further comprise the steps of (F4) receiving, by the input unit, a cooking start instruction for the next stage if the stage performed at step (F3) is ended; (F5) determining, by the control module, whether the input unit has received the cooking start instruction for the next stage at step (F4); and (F6) performing, by the control module, a cooking operation for the next stage, except if the input unit has received an instruction to stop the cooking operation for the next stage at step (F4).

Alternatively, step (F) may comprise the steps of (F1) if the input unit receives the cooking start instruction, detecting data including weight of food put into a cooking chamber and temperature, pressure and humidity in the cooking chamber and changing the cooking method, by the control module, when at least one or more of the detected data are different from those of the cooking method of the selected menu; and (F2) performing the cooking operation in accordance with the cooking method changed at step (F1).

According to a still further aspect of the present invention, there is provided a method of controlling a oven for receiving a variety of operating and setting instructions and displaying various kinds of data related to the instructions, which comprises the steps of (A1) displaying, by a control module, a list of at least one or more menu pages stored in a storage unit on a display unit; (A2) receiving, by an input unit, an instruction to select any one menu page among the menu page list displayed on the display unit at step (A1); and (A3) displaying, by the control module, information on the menu page selected at step (A2) on the display unit, the menu page including a name of the menu page, an avatar corresponding to the menu page name, a menu and a cooking method for the menu.

According to a still further aspect of the present invention, there is provided a method of controlling a oven for receiving a variety of operating and setting instructions and displaying various kinds of data related to the instructions, which comprises the steps of (A1) displaying, by a control module, a list of at least one or more menu pages stored in a storage unit on a display unit; (B1) receiving, by an input unit, an instruction to request registering a new menu page except the menu pages in the menu page list displayed on the display unit at step (A1); (B2) receiving, by the input unit, a menu page name of the new menu page; (B3) registering and storing, by the control module, the menu page name of the new menu page received by the input unit at step (B2) into the menu page list stored in the storage unit; (B4) receiving, by the input unit, information on the new menu page registered in the menu page list at step (B3), the new menu page including an image corresponding to the new menu page, a menu and a cooking method for the menu; and (B5) registering and storing, by the control module, the information on the new menu page received by the input unit at step (B4) into the storage unit.

According to a still further aspect of the present invention, there is provided a method of controlling a oven for receiving a variety of operating and setting instructions and displaying various kinds of data related to the instructions, which comprises the steps of (A1) displaying, by a control module, a list of at least one or more menu pages stored in a storage unit on a display unit; (A2) receiving, by an input unit, an instruction to select any one menu page among the menu page list displayed on the display unit at step (A1); (A3) displaying, by the control module, information on the menu page selected at step (A2) on the display unit, the menu page including a name of the menu page, an avatar corresponding to the menu page name, a menu and a cooking method for the menu; (B1) receiving, by an input unit, an instruction to request registering a new menu page except the menu pages in the menu page list displayed on the display unit at step (A1); (B2) receiving, by the input unit, a menu page name of the new menu page; (B3) registering and storing, by the control module, the menu page name of the new menu page received by the input unit at step (B2) into the menu page list stored in the storage unit, (B4) receiving, by the input unit, information on the new menu page registered in the menu page list at step (B3), the new menu page including an image corresponding to the new menu page, a menu and a cooking method for the menu; and (B5) registering and storing, by the control module, the information on the new menu page received by the input unit at step (B4) into the storage unit.

The image may include at least any one of a still image and a moving image.

The method of the present invention may further comprise the steps of (A4) receiving, by the input unit, an instruction to select any one menu in a list of menus in the menu page displayed on the display unit at step (A3); (A5) receiving, by the input unit, an instruction to start a cooking operation for the menu selected at step (A4); and (A6) performing, by the control module, the cooking operation in accordance with the cooking method for the menu by means of the cooking start instruction received by the input unit at step (A5).

Step (B4) may comprise the steps of (B41) receiving, by the input unit, information on a user which is used as the page menu name of the new menu page received by the input unit at step (B3); and (B42) registering and storing, by the control module, the menu page name received by the input unit at step (B41) into the storage unit.

Step (B4) may further comprise the steps of (B43) receiving, by the input unit, an instruction to register an additional menu other than menus included in the menu page of which menu page name is stored in the storage unit at step (B42); (B44) receiving, by the input unit, a menu name and cooking method for the menu added at step (B43); and (B45) registering and storing, by the control module, the menu name and cooking method for the menu received by the input unit at step (B44) into the storage unit.

Step (B45) may comprise the steps of (B451) receiving, by the input unit, cooking information about each cooking stage; and (B452) registering and storing, by the control module, the cooking information about each cooking stage received by the input unit at step (B451) into the storage unit.

Step (B45) may further comprise the steps of (B453) receiving, by the input unit, a stage advance instruction to change go from the stage stored in the storage unit at step (B452) to a next stage; (B454) initializing a stage item and displaying a stage with an increased stage number on the display unit, by the control module, in response to the stage advance instruction received by the input unit at step (B453); (B455) receiving, by the input unit, cooking information about the stage displayed on the display unit at step (B454); and (B456) registering and storing, by the control module, the cooking information about the stage received by the input unit at step (B455) into the storage unit.

The user information received by the input unit at step (B41) may include at least any one of family's birthday and anniversary and a schedule for an event.

Advantageous Effects

According to the present invention so configured, there are advantages in that an item to be set can be easily discriminated and accurately selected, a cooking method can be easily discriminated and food can be easily cooked accordingly, and a variety of settings can be made according to users.

### BRIEF DESCRIPTION OF THE DRAWINGS

FIG. 1 is a block diagram schematically showing a configuration of a oven for performing a cooking operation including a method of controlling the oven according to a first embodiment of the present invention.

FIG. 2 is a flowchart illustrating a process of displaying a setting state according to the first embodiment of the present invention.

FIG. 3 is an exemplary view showing a menu mode screen displayed on a display unit in the process of displaying a setting state according to the first embodiment of the present invention.

FIG. 4 is a flowchart illustrating a process of displaying a setting state according to a second embodiment of the present invention.

FIG. 5 is a flowchart illustrating a process of performing a cooking method according to a third embodiment of the present invention.

FIG. 6 is an exemplary view showing a cooking method screen displayed on a display unit in the process of performing the cooking method according to the third embodiment of the present invention.

FIG. 7 is a flowchart illustrating a process of managing menus through a menu management method according to a fourth embodiment of the present invention.

FIG. 8 is an exemplary view showing a menu page screen displayed on a display unit in the process of managing menus according to the fourth embodiment of the present invention.

### BEST MODE FOR CARRYING OUT THE INVENTION

First, the term ‘menu’ as used herein refers to a name of food cooked by performing a cooking operation. Further, the term ‘menu list’ as used herein refers to a list of menus, and the term ‘menu mode’ as used herein refers to a mode in which a cooking method can be set in accordance with a specific menu in the menu list. A ‘cooking method’ includes heating mode, heating intensity, heating time and heating temperature for each stage in which the food is cooked in accordance with a menu. Further, an ‘e-cookbook’ has a meaning including both a method of preparing food to cook a certain menu and a method of heating and cooking the food, and also refers to an electronic cookbook through which the cooking is started when a cooking instruction is input.

In addition, the term ‘item’ as used herein refers to a unit of a cooking method by which an operation can be performed by uploading a setting value specified or stored by a user. For example, in a case where a menu is specified, the heating temperature, heating method, heating intensity and heating time for each stage among a cooking method for the menu become the items. Accordingly, respective items and initial setting values of the cooking method for specified menus are displayed together with a menu name on a ‘basic item image.’ Further, a ‘menu setting image’ is an image in which a menu mode is performed. A single item is enlarged and displayed on the menu setting image. At this time, the item enlarged and displayed on the menu setting image is called an ‘initial menu setting item.’ Preferably, the initial menu setting item is set as the uppermost item.

Further, the term ‘display area’ as used herein refers to an area in which an item or menu can be displayed on a display unit. Furthermore, an ‘item display area’ refers to an area in which a certain item is assigned and displayed. The sum of such item display areas is referred to as a ‘total display area.’

Furthermore, the term ‘menu page’ as used herein refers to a unit of list in which at least one or more menus are configured on a single screen. A ‘menu page name’ which is the name of a menu page may be specified with a designation or name of a family member. Thus, a menu page name indicated by the designation or the like of a family member and a favorite menu are included in one menu page. The cooking method and image of the menu are stored together in the menu page.

Hereinafter, a first embodiment of a method of controlling a oven according to the present invention will be described in detail with reference to the accompanying drawing.

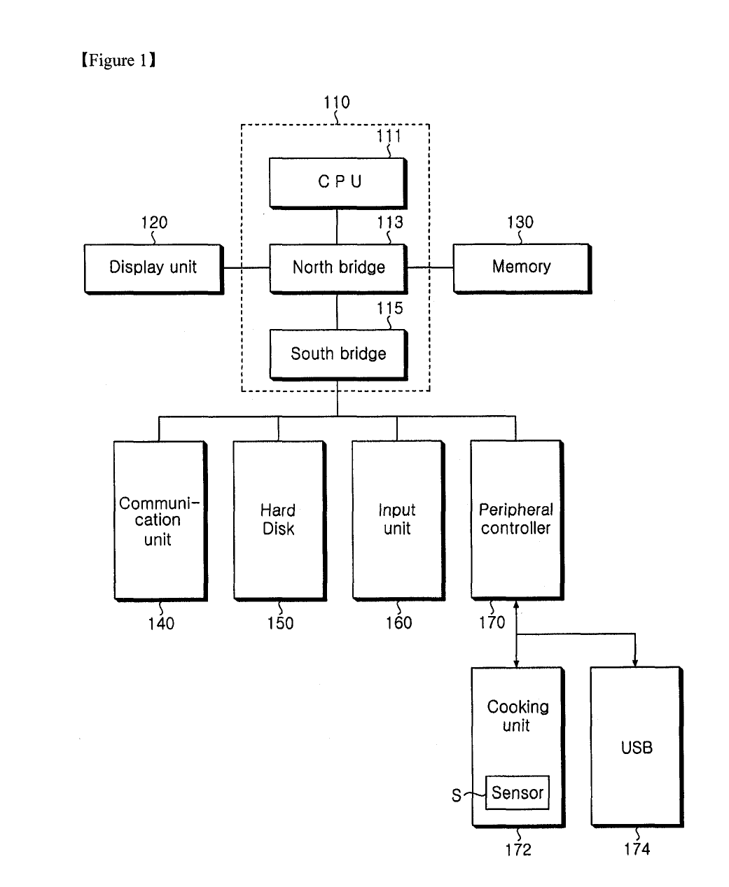

FIG. 1 is a block diagram schematically showing a configuration of a oven for performing a cooking operation including a method of controlling a oven according to a first embodiment of the present invention.

As shown in this figure, the oven for performing the method of controlling a oven according to the present invention comprises a control module 110, a display unit 130, a memory 130, a communication module 140, a hard disk 150, an input unit 160 and a peripheral controller 170.

The control module 110 allows food to be heated and cooked using a cooking unit 172 connected to the peripheral controller 170. Further, the control module 110 functions to execute the control of the display unit 120, the memory 130, the communication module 140, the hard disk 150, the input unit 160 and the peripheral controller 170; the calculation of data; and the logic operation. To this end, the control module 110 comprises north and south bridges 114 and 116 connected in series to a central process unit 112 (hereinafter, referred to as ‘CPU’).

The CPU 112 controls a cooking operation in accordance with an instruction input through the input unit 160. Through a USB (Universal Serial Bus) 174 connected to the communication module 140 or the peripheral controller 170, the CPU 112 controls a menu and a cooking method and image for the menu to be downloaded and stored in the hard disk 150 or controls a content stored in the hard disk 150 to be uploaded and displayed on the display unit 120 in response to a user's instruction input through the input unit 160. Here, the image may be a still image, a moving image or avatar, corresponding to a menu, a cooking method of the menu or a menu page.

More specifically, if an instruction that food is cooked using an electronic cookbook (hereinafter, referred to as an ‘e-cookbook’) is input to the input unit 160, the CPU 112 controls a list of menus stored in the hard disk 150 or a menu page including the menu list to be displayed on the display unit 120 and controls a menu and a cooking method and image for the menu to be displayed on the display unit 120 through the north bridge 114. Further, when a cooking instruction is input to the input unit 160, the CPU 112 sets a cooking method including heating time, heating method, heating intensity and heating temperature for each stage in accordance with the cooking method of a specified menu, and thus controls the cooking to be started using the cooking unit 172.

In addition, if a certain stage is completed in the process of performing the cooking, the CPU 112 controls a message for confirming whether to perform the next stage to be displayed on the display unit 120. Further, in a case where the input unit 160 does not receive an instruction to stop performing the next stage, i.e. in a case where the input unit 160 receives a cooking instruction to start performing the next stage or where the input unit 160 does not receive an instruction to stop performing the next stage for a predetermined time (e.g., 5 seconds), the CPU 112 controls to perform the next stage.

Furthermore, the CPU 112 executes the control of the north and south bridges 114 and 116, the display unit 120, the memory 130, the hard disk 150, the input unit 160, the peripheral controller 170 and the communication module 140; the calculation of data; and the logic operation. To this end, the CPU 112 includes an arithmetic logic unit (ALU), a control unit, a register, a storage unit interface and the like.

The north bridge 114 is connected to the CPU 112 and the south bridge 116 in order to relay bi-directional data communications between the display unit 120 and the memory 130 that are peripheral devices operating at a relatively high speed. Further, the north bridge 114 controls the display unit 120, the memory 130 and the south bridge 116 under the control of the CPU 112. That is, under the control of the CPU 112, the north bridge 114 functions to control an operation state transmitted through the south bridge 116, a menu list and a cooking method and image for a specified menu to be displayed on the display unit 120 or to control the cooking method and image to be uploaded in the memory 130 and also to transmit a control instruction of the CPU 112 to the south bridge 116.

The south bridge 116 is a kind of register group for controlling the input and output of a peripheral device operating at a relatively low speed. The south bridge 116 relays bi-directional data communications between the hard disk 150, input unit 160, peripheral controller 170 or the communication module 140 and the CPU 112 connected thereto via the north bridge 114. Further, the south bridge 116 controls the hard disk 150, the input unit 160, the peripheral controller 170 and the communication module 140, under the control of the CPU 112 connected thereto via the north bridge 114. To this end, the south bridge 116 is connected to the north bridge 114 through a PCI bus (not shown).

The display unit 120 is used to display data processed by the control module 110. A CRT (Cathode Ray Tube), LCD (Liquid Crystal Display) panel, TFT-LCD (Thin Film Transistor Liquid Crystal Display) panel or the like may be used as the display unit 120. To this end, the display unit 120 is connected to the north bridge 114 through an AGP (Accelerated Graphic Part). A cooking state, a menu, and a cooking method and image for the menu can be displayed on the display unit 120 under the control of the CPU 112. In addition, the memory 130 is used to provide an operation space of the control module 110, particularly the CPU 112. In other words, the memory 130 functions to temporarily store data that have been processed or will be processed by the CPU 112. To this end, the memory 130 is connected to the north bridge 114. Although the hard disk 150 and the memory 150 are provided respectively to store and temporarily store data in this embodiment, the memory 130 may be replaced with the hard disk 150 to store data such as a cooking operation method, a menu, a cooking method and image for the corresponding menu.

Furthermore, the communication module 140 relays bi-directional communications between a control system and a communication network. More specifically, the communication module 140 transmits data from a public telephone network or local area network toward the control module 110 (i.e., the CPU 112 via the south and north bridges 116 and 114) or transmits data from the control unit 110 (i.e., the CPU 112 via the north and south bridges 114 and 116) toward the public telephone network or local area network. To this end, the communication module 140 is connected to the south bridge 116 through PCI or USB. A cooking method and image for a menu is contained in the data transmitted by the communication module 140.

The hard disk 150 functions to store various programs including an operating system (OS), and cooking methods and images for menus. It is apparent that a system program such as OS and various kinds of application programs may be stored in an additional memory called ROM. The operating system stored in the hard disk 150 is uploaded into the memory 130 when the system is booted. Further, various kinds of application programs stored in the hard disk 150 are uploaded into the memory 130 according to a user's selection.

The input unit 160 functions to receive a user's instruction, e.g. an instruction for a cooking operation and an instruction for the setting of a menu and a menu page, and then transmit the received instruction in a key-data format to the CPU 112 via the south and north bridges 116 and 114. For example, the input unit 160 may include menu selection keys and change keys (not shown) for the cooking operation or menu setting, and a cooking start key (not shown) through which the specified menu can be cooked.

The peripheral controller 170 functions to control data inputs/outputs between the control system and the cooking unit 172. In other words, the peripheral controller 170 relays bi-directional data communications between the control module 110 and the cooking unit 172 to be controlled. Further, the peripheral controller 170 may be connected to a portable terminal through the USB 174.

The cooking unit 172 comprises various kinds of components used to substantially cook food. For example, the cooking unit 172 comprises various kinds of electrical components for oscillating microwaves, a heater for generating heat, a turn table for rotating food, and the like. Further, sensors S are provided in the cooking unit 172. The sensors S are used to detect weight of food to be cooked and the temperature, humidity and pressure in a cooking room of the cooking unit 172. Such data detected by the sensors S are transmitted to the control module 112.

In a state where the peripheral controller 170 is connected to a portable terminal through the USB 174, the peripheral controller downloads a menu and a cooking method and image for the menu from the portable terminal and stores the downloaded data in the hard disk 150 under the control of the control module 110.

Hereinafter, a process of displaying a setting state according to a first embodiment of the present invention will be described in detail with reference to accompanying drawings.

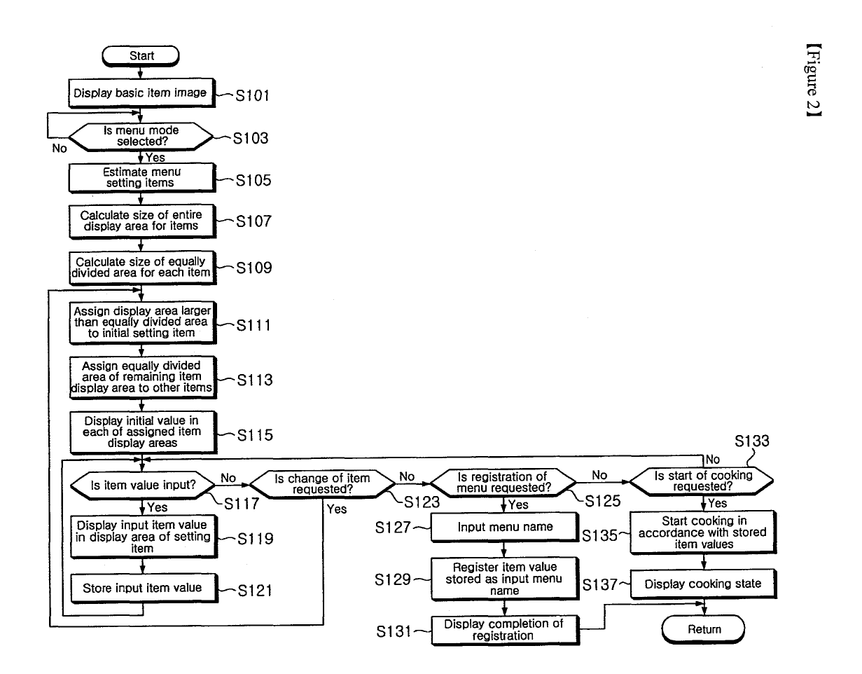

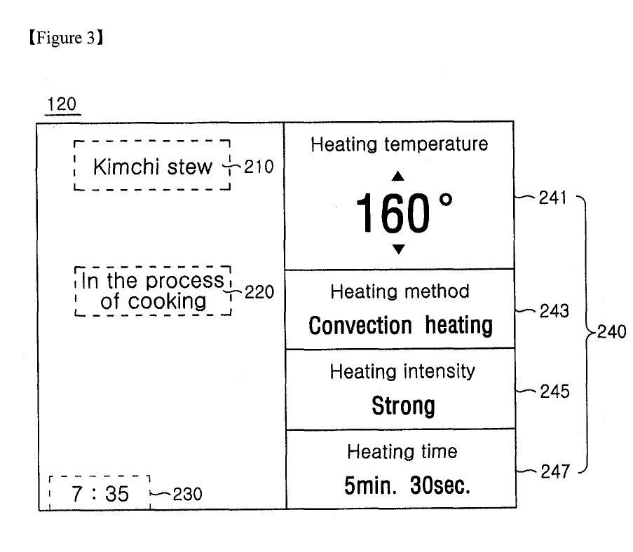

FIG. 2 is a flowchart illustrating a process of displaying a setting state according to the first embodiment of the present invention, and FIG. 3 is an exemplary view showing a menu mode screen displayed on a display unit in the process of displaying a setting state according to the first embodiment of the present invention.

As shown in these figures, the control module 110 first controls a basic item image for a certain menu to be displayed on the display unit 120 (S101). Here, in a case where one menu is specified to perform the cooking operation, items for the menu and initial setting values thereof are displayed on the basic item image. For example, if a menu “Kimchi stew” is specified, the basic item image includes items such as a heating time of 5 minutes, a heating intensity of ‘strong,’ a heating method of magnetron driving and a heating temperature of 150° C. for a first stage, and items of heating time, heating intensity, heating method, heating temperature and the like for a second stage, together with the menu name “Kimchi stew.” Simultaneously, a current time may be displayed in the basic item image.

Meanwhile, if a menu mode selection instruction is input in a state where the basic item image is displayed on the display unit 120 (S103), the control module 110 estimates menu setting items (S105). Then, the control module 110 calculates an entire size of a display area on which the estimated items will be displayed (S107) and equally divides the entire display area to calculate a size of an item display area on which one item will be displayed (S109).

Thereafter, the control module 110 assigns a display area larger than the equally divided area to an initial menu setting item (S111) and equally divides the remaining item display area to assign the equally divided display area to each of the other items (S113). In a state where each display area is assigned in such a manner, the control module 110 displays an initial value in each of the assigned item display areas (S115).

Next, the control module 110 determines whether an instruction to request input of an item value is input (S117) and displays the input item value in the display area of a setting item (S119). Then, the control module 110 stores the item value input at step S119 into the hard disk 150 (S121).

Through such a process of assigning display areas, the control module 110 equally divides the entire display area to estimate item display areas. The control module 110 assigns a display area larger than the equally divided item display area to an initial menu setting item such that the initial menu setting item can be displayed at a size relatively enlarged as compared with the other items. At this time, the control module 110 may enlarge a font size of the item value of the initial menu setting item or allow font and ground colors of the item display area to be reversed or changed.

On the other hand, in a case where an instruction to request the input of an item value is not input at step S117, the control module 110 checks whether an instruction to change a setting item into another item is input (S123). Further, in a case where an instruction to request change of the setting item is input, the control module 110 changes the setting item and executes steps S117 to S121. Accordingly, the control module 110 executes processes of receiving the item value of another item to change the set item value into the input item value, enlarging the display area to display the enlarged display area on the display unit 120, and storing the input item value into the hard disk 150.

Then, if an instruction to request the change of a setting item is not input at step S123, the control module 110 determines whether an instruction to requests registration of a menu for the item value is input (S125). Further, in a case where an instruction to request the registration of a menu is input, the control module 110 receives a new menu name input by a user through the input unit 160 (S127) and registers the new menu name into a menu list together with the item value stored as the input menu name (S129). Next, the control module 110 allows the completion of registration of the new menu to be displayed on the display unit 120 (S131).

On the other hand, in a case where an instruction to request the registration of a menu for the item value is not input at step 125, the control module 110 determines whether an instruction to request the start of cooking related to the item value is input (S133). In a case where the control module 110 determines that the cooking start instruction is input, the control module 110 starts cooking in accordance with the stored item value (S135) and displays a current cooking state on the display unit 120 (S137). Further, if an instruction to request the start of cooking is not input, the control module 110 determines whether an instruction to request the input of an item value is input at step S117 and then repeatedly performs the aforementioned steps after step S117.

As shown in FIG. 3, a menu name 210 (e.g., “Kimchi stew”), a cooking state 220 (e.g., “at cooking”) and a current time 230 are displayed on the display unit 120, while items 240 related to the relevant menu are arranged at the right side of a screen. FIG. 3 shows a state where a heating temperature 241 in the items 240 displayed on the display unit 120 is set as a setting item. The heating temperature 241 displayed on the display unit 120 is displayed in a display area relatively larger than those of the other items, i.e. heating method 243, heating intensity 245 and heating time 247. Accordingly, a user can easily discriminate a setting item, i.e. the heating temperature 241, from the other items.

Through the processes of registering a menu and performing the cooking of the menu as described above, a user may create a new menu for a changed item value and perform the cooking of the new menu in accordance with the item value. Further, an item set in the aforementioned process of assigning display areas is assigned to an area larger than the other items, so that a user can easily discriminating the set item from the other items.

The present invention is not limited to the aforementioned embodiment but defined by the appended claims. Further, it will be understood by those skilled in the art that various changes and modifications can be made thereto without departing from the technical spirit and scope of the present invention.

Although it has been described in the aforementioned embodiment that a menu is specified and a setting state of an item is changed according to the menu mode selection, the scope of the present invention is not necessarily limited thereto. That is, the present invention may be applied to not only the setting state of an item described according to the present invention but also an image including a plurality of items such as a menu list or menu page list such that the setting item can be enlarged and displayed.

### MODE FOR CARRYING OUT THE INVENTION

Next, a second embodiment of a method of controlling a oven according to the present invention will be described with reference to the accompanying drawing.

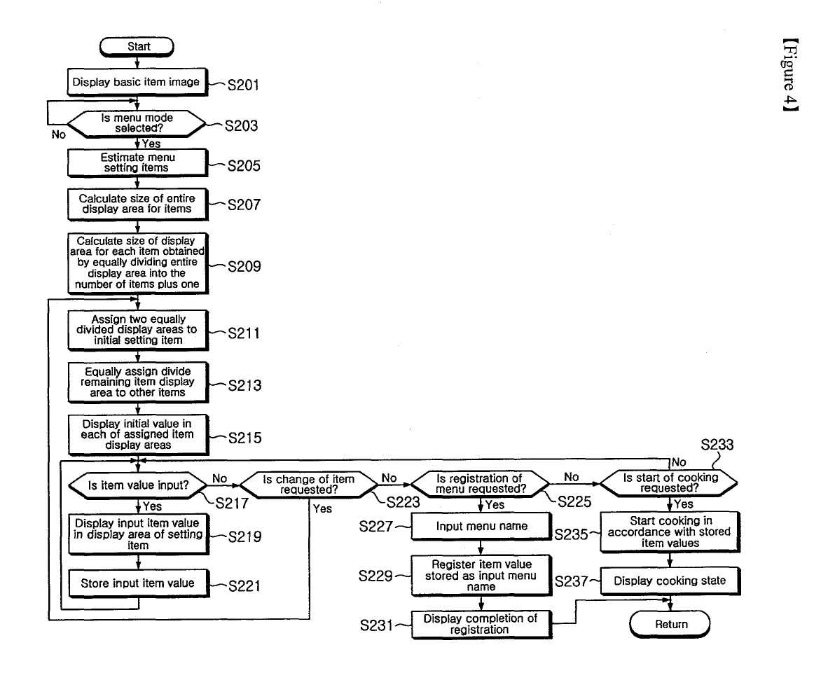

FIG. 4 is a flowchart illustrating a process of displaying a setting state according to the second embodiment of the present invention.

A control module and the like of this embodiment are identical with those of the first embodiment of the present invention. Further, since steps S211 to S207 and S217 to S237 in the process of displaying a setting state according to this embodiment are identical with steps S101 to S107 and S117 to S137 in the first embodiment of the present invention, detailed descriptions thereof will be omitted herein.

The control module 110 equally divides the size of an entire display area, in which items estimated at the step S207 are displayed on a display unit 120, into (the number of items) plus 1 (one) to calculate the size of a display area for each item (S209). Further, the control module 110 assigns the two equally divided areas to an initial menu setting item (S211). In a state where the two equally divided areas are assigned to the initial menu setting item in such a manner, the control module 110 assigns the remaining equally divided areas to the other items, respectively (S213). Thereafter, the control module 110 performs a process of receiving an item value from each of the assigned item display areas, displaying the item value on the display unit 120 and storing the item value into a hard disk 150 (S215, S217, S219 and S221).

In this embodiment, equally divided areas are created by one plus the number of items to assign the two equally divided areas to a current setting item, so that a user can discriminate the current setting item from the other items.

Next, a fourth embodiment of a method of controlling a oven according to the present invention will be described in detail below with reference to the accompanying drawings.

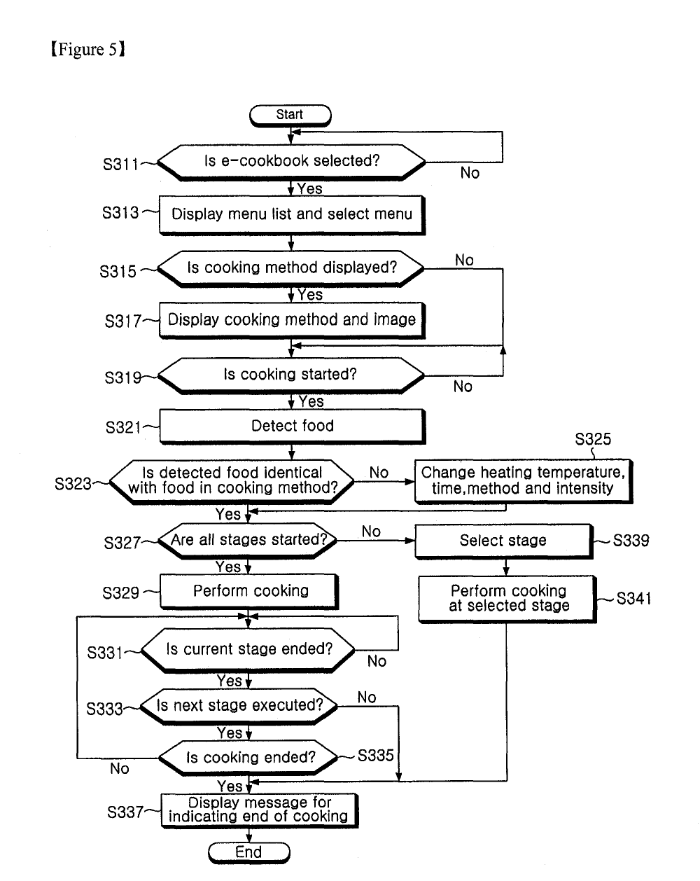

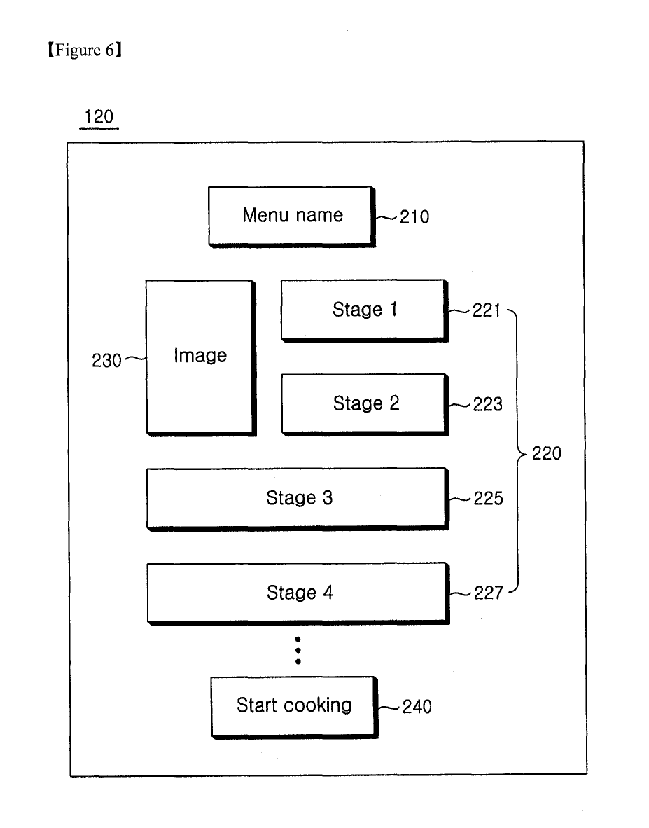

FIG. 5 is a flowchart illustrating a process of implementing a cooking method according to the third embodiment of the present invention, and FIG. 6 is an exemplary view showing a screen for the cooking method displayed on a display unit in the process of implementing the cooking method according to the third embodiment of the present invention.

As shown in these figures, an instruction to select an e-cookbook is first input to an input unit 160 (S311). If the instruction to select an e-cookbook is input to the input unit 160, a control module 110 controls a menu list stored in a hard disk 150 to be displayed on a display unit 120, and then a user selects one menu in the menu list displayed on the display unit 120 (S313).

Further, the control module 110 determines whether an instruction to request the display of a cooking method and image of the specified menu is input (S315). If it is determined that an instruction to request the display of the cooking method is input, the control module 110 controls the cooking method and image of the specified menu stored in the hard disk 150 to be uploaded into a memory 130 and displayed on the display unit 120 (S317). For example, as shown in FIG. 6, a menu name 310 and a cooking method 320 and image 330 for a menu are simultaneously displayed on the display unit 120. Here, the cooking method 320 is divided into respective stages 321, 323, 325 and 327, which in tune are displayed on the display unit 120. Further, a cooking start confirmation message 340 for confirming whether to start the cooking in accordance with the cooking method for the menu is displayed on the display unit 120.

Meanwhile, in a case where the control unit 110 determines that the cooking method and image for the menu is displayed on the display unit 120 at step S317 or that an instruction to request the display of the cooking method and image for the menu is not input at step S315, the control unit 110 determines whether an instruction to request the start of cooking is input (S319). Further, if it is determined that the instruction to request the start of cooking is input, the control module 110 determines whether data for the cooking materials and the temperature, weight, humidity and pressure in a cooking room, which are detected by various kinds of sensors S installed in a cooking unit 172, are identical with data for the conditions of a cooking method in the e-cookbook stored in the hard disk 150 (S323). At this time, it is determined that the data detected by the sensors S are different from the data for the cooking method in the e-cookbook, the control module 110 controls a cooking method, i.e. heating intensity, heating time, heating temperature, heating method and the like to be changed and set in accordance with the weight of food and the temperature, humidity and pressure in the cooking room on the basis of a changing method previously stored in the hard disk 150 (S325).

Next, the control module 110 determines whether an instruction to request all the stages contained in the cooking method to be executed is input (S327). If it is determined that the instruction to request the execution of all the stages is input at step S327, the control module 110 controls a first stage of the cooking method to be executed by the cooking unit 172 (S329). Further, the control module 110 counts a cooking time using a timer (not shown) to determine whether the first stage is ended (S331). If it is determined that the first stage is ended, the control module 110 determines whether the next stage is executed (S333). In a case where it is not determined that an instruction to request the stop of cooking at the next stage is input at step S333, i.e. in a case where an instruction to request the execution of the next stage is input or where the execution of the next stage is stopped or an instruction to request the stop of the next stage is not input for a predetermined time, the control module 110 drives the cooking unit 172 to control the cooking in accordance with the cooking method of the next stage. At this time, the control module 110 repeatedly performs steps S331 and S333 until all the stages of the cooking method are ended. Further, if all the stages of the cooking method are ended, the control module 110 allows a message for indicating the end of cooking to be displayed on the display unit 120 (S337).

On the other hand, in a case where the control module 110 determines that an instruction to request a part of the stages of the cooking method to be executed is input at step S327, the input unit 160 receives an instruction to select any one or more of the stages of the cooking method (S339). Further, the control module 110 drives the cooking unit 172 to execute the stage selected at step S339 (S341). Then, if the stage selected at step S341 is ended, the control module 110 allows step S337 to be executed.

Next, a fourth embodiment of a method of controlling a oven according to the present invention will be described in detail with reference to the accompanying drawings.

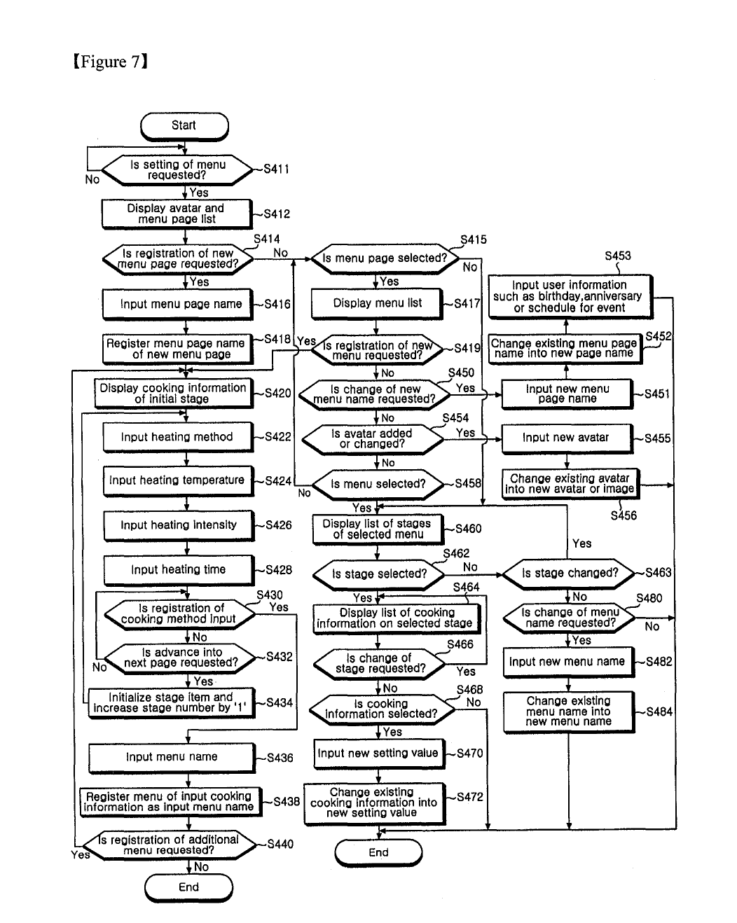

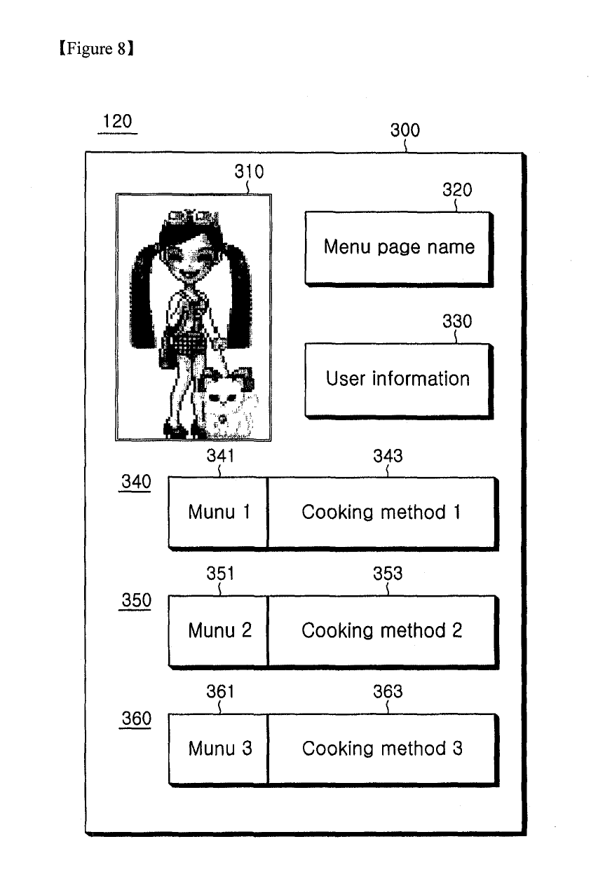

FIG. 7 is a flowchart illustrating a process of managing menus through a menu management method according to the fourth embodiment of the present invention, and FIG. 8 is an exemplary view showing a menu page screen displayed on the display unit in the process of managing menus according to the fourth embodiment of the present invention.

As shown in these figures, if a menu setting instruction is input to an input unit 160 (S411), a control module 110 controls a menu page list and an image, which are stored in a hard disk 150, to be uploaded and displayed on a display unit 120 (S412). At this time, the image displayed on the display unit 120 may be any one or more of a still image, a moving image and an avatar.

As shown in FIG. 8, a menu page 300 displayed on the display unit 120 is composed of an avatar 310, a name of the menu page 320, (a user information 330) and menus 340, 350 and 360. Here, a variety of different avatars may be used according to users. It will be apparent that a still or moving image may be included in the menu page 200 in place of the avatar. Further, the user information 330 may be various kinds of information on a user specified as a name of the menu page, e.g. personal information such as user's birthday and anniversary or a schedule for an event. The menus 340, 350 and 360 may be included in the menu page 300 according to the user's selection. Menu names 341, 351 and 361, and cooking methods 343, 353 and 363 for the menu names 341, 351 and 361 are displayed on the display unit 120.

Then, the control module 110 confirms whether the input unit 160 has received an instruction to register a new menu page (S414). The control module 110 registers a name of the menu page received through the input unit 160 and stores the registered menu page name into the hard disk 150 (S416) (S418). Here, the name or designation of a user may be used as the menu page name stored in the hard disk 150. For example, in a case where a family comprising parents and children are users, the name of any one or the respective members of the family may be used as the menu page name.

Furthermore, the control module 110 controls the menu page name registered at step S418 and a cooking information of the initial stage of a menu included in the menu page name to be displayed on the display unit 120 (S420). Further, the input unit 160 receives information on the cooking method of the initial stage of the menu included in the new menu page displayed on the display unit 120, i.e. heating method, heating temperature, heating intensity and heating time (S422, S424, S426 and S428). Then, the control module 110 determines whether the input unit 160 receives an instruction to request the registration of the cooking method included in the initial stage of the menu input at steps S422 to S428. If it is determined that the input unit 160 receives an instruction to request the registration of the cooking method (S430), the control module 110 allows the cooking method together with the menu name received by the input unit 160 to be registered and stored in the hard disk 150 (S436 and S438). Of course, the control module 110 may allow the menu and the cooking method for the menu stored in the hard disk 150 to be uploaded according to the user's selection and also to be registered as a menu and cooking method into the new menu page, and then, to be stored in the hard disk 150.

On the other hand, if it is determined at step S430 that the input unit 160 has not received the instruction to request the registration of the cooking method input at steps S422 to S428, the control module 110 determines whether the input unit 160 receives an instruction to request the advance into the next stage (S432). Further, if the input unit 160 receives an instruction to go to the next stage, the control module 110 allows a stage item to be initialized and allows a stage number to be increased by ‘1’ such that the next stage can be displayed on the display unit 120 (S434). In a state where the next stage is displayed on the display unit 120 at step S434, steps S422 to S434 are repeatedly performed such that information on the cooking method of the next stage can be input, registered and stored.

If the cooking information of one stage for a certain menu included in the new menu page is created and stored through the aforementioned steps, the control module 110 determines whether the input unit 160 has received an instruction to request the input of another menu which will be included in the new menu page (S440). Then, if it is determined that the input unit 160 has received an instruction to request the input of another menu which will be included in the new menu page at step S440, the control module 110 repeatedly performs the steps S410 to S440 to set the cooking information of stages of another menu which will be included in the new menu page. Further, if it is determined that the input unit 160 has not received an instruction to request the input of another menu which will be included in the new menu page at step S440, the control module 110 terminates the menu setting of the new menu page.

On the other hand, if it is determined that the input unit 160 has not received an instruction to request the registration of the new menu page at step S414, the control module 110 determines whether the input unit 160 receives an instruction to select any one of menu pages previously stored in the hard disk 150 (S415). Then, if it is determined that the input unit 160 has received an instruction to select any one of menu pages at step S415, the control module 110 allows a menu list included in the selected menu page to be displayed on the display unit 120 (S417).

In such a state, the control module 110 determines whether the input unit 160 has received an instruction to request the registration of a new menu other than the menu list of the menu page displayed on the display unit 120 (S419). Then, if it is determined that the input unit 160 has received the instruction to request the registration of a new menu at step S419, the control module 110 repeatedly performs steps S420 to S440 to register the new menu included in the menu page.

Further, if it is determined that the input unit 160 has not received the instruction to request the registration of a new menu at step S419, the control module 110 determines whether the input unit 160 has received an instruction to request the change of the menu page name (S450).

If it is determined that the input unit 160 has received an instruction to request the change of the menu page name at step S450, the control module 110 changes the menu page name into a new menu page name (S451) such that the new menu page name can be displayed on the display unit 120 and be registered to store the new menu page name into the hard disk 150 (S452). If user information related to the menu page name stored as the new menu page name, e.g. the user's birthday and anniversary, the schedule for event or the like, is input through the input unit 160 after the menu page name has been changed into a new menu page name which in turn has been stored at step S452, the control module 110 allows the input user information not only to be displayed on the input unit 120 but also to be registered and stored in the hard disk 150 (S453).

In a case where the input unit has not received an instruction to request the change of the menu page name, the control module 110 determines whether the input unit 160 has received an instruction to request the addition or change of an image, particularly an avatar, corresponding to the menu page (S454). Then, if it is determined that the input unit 160 has received an instruction to request the addition or change of an avatar at step S454, the control module 110 causes avatars previously stored in the hard disk 150 to be uploaded and displayed on the display unit 120 such that the input unit 160 receives an instruction to select any one of the avatars (S455). If the input unit 160 receives an instruction to select any one of the avatars at step S455, the control module 110 causes the selected avatar to be added or replaced with the existing avatar such that the selected avatar can be displayed on the display unit 120. Simultaneously, the control module 110 registers and stores the added or replaced avatar into the hard disk 150 (S456).

However, if it is determined that the input unit 160 has not received an instruction to request the addition or change of an avatar at step S454, the control module 110 determines whether the input unit 160 has received an instruction to select any one menu in the menu list included in the menu page displayed on the display unit 120 at step S419 (S458). Further, in a case where the input unit 160 has not received an instruction to select any one menu in the menu list at step S458, the control module 110 causes a process to be returned to step S415.

However, in a case where the input unit 160 receives an instruction to select any one menu in the menu list at step S458, the control module 110 causes a list of stages of the selected menu to be displayed on the display unit 120 (S460). Then, the control module 110 confirms whether the input unit 160 has received an instruction to select any one stage in the stage list of the menu displayed on the display unit 120 at step S460 (S462). If it is determined that the input unit 160 has not received an instruction to select any one stage in the stage list at step S462, the control module 110 confirms whether the input unit 160 has received an instruction to change the stage (S463). If the input unit 160 has received an instruction to change the stage at step S463, the control module 110 causes a process to be returned to step S460. If the input unit 160 has not received the instruction to change the stage, the control module 110 determines whether the input unit 160 has received an instruction to request the change of the menu name (S480). Further, in a case where the input unit 160 has received an instruction to request the change of the menu name at step S480, a new menu name is input to the input unit 160 (S482). Then, the control module 110 changes the current menu name into the new menu name such that the new menu name can be displayed on the display unit 120. Further, the control module registers and stores the new menu name into the hard disk 150 (S484).

Meanwhile, in a case where the input unit 160 receives an instruction to select any one stage in the stage list at step S462, the control module 110 causes a list of cooking information on the selected stage to be displayed on the display unit 120 (S464). Further, the control module 110 determines whether the input unit 160 has received an instruction to request the change of the stage. In a case where the input unit 160 has received an instruction to request the change of the stage, the control module 110 causes a list of cooking information on the changed stage to be displayed on the display unit 120 (S464). Then, if the list of cooking information on the changed stage is displayed on the display unit 120 at step S464, the control module 110 repeatedly performs steps after step S466.

On the other hand, in a case where an instruction to request the change of the stage is not input at step S466, the control module 110 determines whether the input unit 160 has received an instruction to select any one of the cooking information on the stage displayed on the display unit 120 (S468). Further, in a case where the input unit 160 has received an instruction to select the cooking information of the stage at step S468, the control module 110 changes the existing setting value for the cooking information of the stage into a new setting value for new cooking information of a stage input to the input unit 160 such that the new setting value can be displayed on the display unit 120 and registered and stored in the hard disk 150.

### INDUSTRIAL APPLICABILITY

As described above, according to a oven of the present invention and a method of controlling the oven, the following advantages can be expected:

First, according to the present invention, an entire display area in which a menu is displayed is equally divided into display areas with the number of menu items or the number greater than the number of items by 1 (one), and a setting item is displayed relatively largely at a relevant display area or is displayed over the two display areas. Accordingly, a user can easily discriminate the setting item from the other items.

Further, a user can easily discriminate a relevant setting item from the other items in this manner, and thus, an input error can be avoided in the process of setting an item. Therefore, a user can more conveniently use a oven.

In addition, according to the present invention, the cooking method and image for a certain menu are simultaneously displayed for each stage. Accordingly, a user can more easily identify a cooking method for cooking food.

Further, in a case where conditions of a cooking method for a menu according to the present invention are different from those for the actual cooking, the cooking method is changed and then performed. Accordingly, a user can simply perform the cooking using a oven.

Furthermore, according to the present invention, a menu page including different menus and avatars according to users can be created, and the cooking method and image for a specific menu can be stored in the menu page. Accordingly, a user can more conveniently use a oven since the menu can be managed in accordance with his/her taste.

1. A method of controlling a oven for receiving a variety of operating and setting instructions and displaying various kinds of data related to the instructions, the method comprising the steps of:
(A) displaying, by a control module, any one of menu lists included in a menu list image on a display unit to be relatively larger than the other menu lists;
(B) receiving, by an input unit, an instruction to select any one of the menu lists displayed on the display unit at step (A);
(C) displaying, by the control module, the menu list selected at step (B) on the display unit to be relatively larger than the other menu lists;
(D) receiving, the input unit, an instruction to select any one of menus included in the menu list selected at step (B);
(E) displaying, by the control module, a cooking method and image for the menu selected at step (D) on the display unit;
(F) receiving, by the input unit, a cooking start instruction; and
(G) performing a cooking operation in accordance with the cooling method for the menu selected at step (D) by means of the cooking start instruction received by the input unit at step (F).

2. A method of controlling a oven for receiving a variety of operating and setting instructions and displaying various kinds of data related to the instructions, the method comprising the steps of:
(A) displaying, by a control module, any one of menu setting items included in a menu setting image on a display unit to be relatively larger than an equally divided area of an entire display area and displaying the other menu setting items in equally divided areas of a remaining display area, respectively;
(B) receiving, by an input unit, an instruction to select any one of the menu setting items displayed on the display unit at step (A); and
(C) displaying, by the control module, the menu setting item selected at step (B) on the display unit to be relatively larger than the equally divided area of the entire display area and displaying the other menu setting items in equally divided areas of a remaining display area, respectively.

3. A method of controlling a oven for receiving a variety of operating and setting instructions and displaying various kinds of data related to the instructions, the method comprising the steps of:
(A) displaying, by a control module, any one of menu setting items included in a menu setting image on a display unit to be placed on two of equally divided areas obtained by equally dividing an entire display area into the number of menu setting items plus 1 (one) and displaying the other menu setting items to be placed on the remaining item display areas, respectively;
(B) receiving, by an input unit, an instruction to select any one of the menu setting items displayed on the display unit at step (A); and
(C) displaying, by the control module, the menu setting item selected at step (B) on the display unit to be placed on the two equally divided areas and displaying the other menu setting items to be placed on the remaining item display areas, respectively.

4. The method as claimed in claim 2, wherein step (B) comprises the steps of:
(B1) displaying, by the control module, an initial value on each of the item display areas assigned to the display unit;
(B2) receiving, by the input unit, an instruction to input an item value displayed in the item display area;
(B3) displaying, by the control module, the item value input at step (B2) on the item display area; and
(B4) storing, by the control module, the item value input at step (B2) in a storage unit.

5. The method as claimed in claim 4, wherein step (B3) comprises the steps of:
(B31) receiving, by the input unit, an instruction to change an item displayed on the item display area into another item;
(B32) displaying, by the control module, a list of items on the item display area in accordance with the item change instruction input at step (B31); and
(B33) receiving, by the input unit, an instruction to select one item in the item list displayed at step (B32).

6. The method as claimed in claim 5, wherein step (B31) comprises the steps of:
(B311) receiving, by the input unit, an instruction to request registering a menu including an item with a changed item value;
(B312) receiving, by the input unit, an instruction to input a new menu name of a menu which will be registered in accordance with the menu registration instruction; and
(B313) storing, by the control module the menu including the item with the item value changed at step (B311) in the storage unit.

7. The method as claimed in claim 2, further comprising the steps of:
(D) receiving, by the input unit, a cooking start instruction in accordance with the selected menu item;
(E) performing, by the control module, a cooking operation in accordance with the item value stored in the menu item selected at step (B) by means of the cooking start instruction received by the input unit at step (D); and
(F) displaying, by the control module, a current cooking state on the display unit.

8. A method of controlling a oven for receiving a variety of operating and setting instructions and displaying various kinds of data related to the instructions, the method comprising the steps of:
(A) receiving, by an input unit, a menu mode selection instruction;
(B) displaying, by a control module, a menu list stored in a storage unit on a display unit in accordance with the menu mode selection instruction received by the input unit at step (A);
(C) receiving, by the input unit, an instruction to select any one menu in the menu list displayed on the display unit at step (B);
(D) displaying, by the control module, a cooking method and image for the menu received by the input unit at step (C) on the display unit;
(E) receiving, by the input unit, a cooking start instruction; and
(F) performing, by the control module, a cooking operation in accordance with the cooking method for the menu displayed on the display unit at step (D) by means of the cooking start instruction received by the input unit at step (E).

9. The method as claimed in claim 8, wherein the image includes at least one of a still image, a moving image and an avatar, which are related to the menu or cooking method.

10. The method as claimed in claim 8, wherein the cooking method displayed on the display unit at step (D) includes at least one of heating intensity, heating method, heating temperature and heating time for each cooking stage.

11. The method as claimed in claim 8, wherein step (F) comprises the steps of:
(F1) receiving, by the input unit, an instruction to select any one of stages;
(F2) determining, by the control module, whether the input unit has received an instruction to select any one of stages at step (F1); and
(F3) performing, by the control module, a cooking operation at the selected stage by means of the stage selection instruction received by the input unit at step (F2).

12. The method as claimed in claim 11, wherein step (F) further comprises the steps of:
(F4) receiving, by the input unit, a cooking start instruction for the next stage if the stage performed at step (F3) is ended;
(F5) determining, by the control module, whether the input unit has received the cooking start instruction for the next stage at step (F4); and
(F6) performing, by the control module, a cooking operation for the next stage, except if the input unit has received an instruction to stop the cooking operation for the next stage at step (F4).

13. The method as claimed in claim 8, wherein step (F) comprises the steps of:
(F1) if the input unit receives the cooking start instruction, detecting data including weight of food put into a cooking chamber and temperature, pressure and humidity in the cooking chamber and changing the cooking method, by the control module, when at least one or more of the detected data are different from those of the cooking method of the selected menu; and
(F2) performing the cooking operation in accordance with the cooking method changed at step (F1).

14. A method of controlling a oven for receiving a variety of operating and setting instructions and displaying various kinds of data related to the instructions, the method comprising the steps of:
(A1) displaying, by a control module, a list of at least one or more menu pages stored in a storage unit on a display unit;
(A2) receiving, by an input unit, an instruction to select any one menu page among the menu page list displayed on the display unit at step (A1); and
(A3) displaying, by the control module, information on the menu page selected at step (A2) on the display unit, the menu page including a name of the menu page, an avatar corresponding to the menu page name, a menu and a cooking method for the menu.

15. A method of controlling a oven for receiving a variety of operating and setting instructions and displaying various kinds of data related to the instructions, the method comprising the steps of:
(A1) displaying, by a control module, a list of at least one or more menu pages stored in a storage unit on a display unit;
(B1) receiving, by an input unit, an instruction to request registering a new menu page except the menu pages in the menu page list displayed on the display unit at step (A1);
(B2) receiving, by the input unit, a menu page name of the new menu page;
(B3) registering and storing, by the control module, the menu page name of the new menu page received by the input unit at step (B2) into the menu page list stored in the storage unit;
(B4) receiving, by the input unit, information on the new menu page registered in the menu page list at step (B3), the new menu page including an image corresponding to the new menu page, a menu and a cooking method for the menu; and
(B5) registering and storing, by the control module, the information on the new menu page received by the input unit at step (B4) into the storage unit.

16. A method of controlling a oven for receiving a variety of operating and setting instructions and displaying various kinds of data related to the instructions, the method comprising the steps of:
(A1) displaying, by a control module, a list of at least one or more menu pages stored in a storage unit on a display unit;
(A2) receiving, by an input unit, an instruction to select any one menu page among the menu page list displayed on the display unit at step (A1);
(A3) displaying, by the control module, information on the menu page selected at step (A2) on the display unit, the menu page including a name of the menu page, an avatar corresponding to the menu page name, a menu and a cooking method for the menu;
(B1) receiving, by an input unit, an instruction to request registering a new menu page except the menu pages in the menu page list displayed on the display unit at step (A1);
(B2) receiving, by the input unit, a menu page name of the new menu page;
(B3) registering and storing, by the control module, the menu page name of the new menu page received by the input unit at step (B2) into the menu page list stored in the storage unit;
(B4) receiving, by the input unit, information on the new menu page registered in the menu page list at step (B3), the new menu page including an image corresponding to the new menu page, a menu and a cooking method for the menu; and
(B5) registering and storing, by the control module, the information on the new menu page received by the input unit at step (B4) into the storage unit.

17. The method as claimed in claim 14, wherein the image includes at least any one of a still image and a moving image.

18. The method as claimed in claim 14, further comprising the steps of:
(A4) receiving, by the input unit, an instruction to select any one menu in a list of menus in the menu page displayed on the display unit at step (A3);
(A5) receiving, by the input unit, an instruction to start a cooking operation for the menu selected at step (A4); and
(A6) performing, by the control module, the cooking operation in accordance with the cooking method for the menu by means of the cooking start instruction received by the input unit at step (A5).

19. The method as claimed in claim 15, wherein step (B4) comprises the steps of:
(B41) receiving, by the input unit, information on a user which is used as the page menu name of the new menu page received by the input unit at step (B3); and
(B42) registering and storing, by the control module, the menu page name received by the input unit at step (B41) into the storage unit.

20. The method as claimed in claim 19, wherein step (B4) further comprises the steps of:
(B43) receiving, by the input unit, an instruction to register an additional menu other than menus included in the menu page of which menu page name is stored in the storage unit at step (B42);
(B44) receiving, by the input unit, a menu name and cooking method for the menu added at step (B43); and
(B45) registering and storing, by the control module, the menu name and cooking method for the menu received by the input unit at step (B44) into the storage unit.

21. The method as claimed in claim 20, wherein step (B45) comprises the steps of:
(B451) receiving, by the input unit, cooking information about each cooking stage; and
(B452) registering and storing, by the control module, the cooking information about each cooking stage received by the input unit at step (B451) into the storage unit.

22. The method as claimed in claim 21, wherein step (B45) further comprises the steps of:
(B453) receiving, by the input unit, a stage advance instruction to change go from the stage stored in the storage unit at step (B452) to a next stage;
(B454) initializing a stage item and displaying a stage with an increased stage number on the display unit, by the control module, in response to the stage advance instruction received by the input unit at step (B453);
(B455) receiving, by the input unit, cooking information about the stage displayed on the display unit at step (B454); and
(B456) registering and storing, by the control module, the cooking information about the stage received by the input unit at step (B455) into the storage unit.

23. The method as claimed in claim 19, wherein the user information received by the input unit at step (B41) includes at least any one of family's birthday and anniversary and a schedule for an event.
